(19) United States
(12) Patent Application Publication
(10) Pub. No.: US 2009/0099688 A1
(43) Pub. Date: Apr. 16, 2009

(54) Integral robot system and method for the dislodging process and/or anode handling from casting wheels

(76) Inventor: Hugo Salamanca, Santiago (CL)

Correspondence Address: GOTTLIEB RACKMAN & REISMAN PC, 270 MADISON AVENUE, 8TH FLOOR, NEW YORK, NY, 10016-0601, US

(21) Appl. No.: 11/595,962

(22) Filed: Nov. 13, 2006

Related U.S. Application Data
(60) Provisional application No. 60/734,987, filed on Nov. 10, 2005.

(51) Int. Cl. G06F 19/00; B22D 11/20

(52) U.S. Cl. 700/245; 164/413; 901/31; 901/47

(57) ABSTRACT

At present, the tasks associated to the dislodging process and/or anode handling from casting wheels is characterized by the exposure of the personnel to harsh environmental conditions. As well as the use of take-off mechanisms with a high rate of failures. This, in the medium and long term, could generate serious occupational illnesses to the operators in charge of carrying out this activity such as decrease and/or delays in production. Due to the above, an integral robot system and method have been developed for the dislodging process and/or anode handling from casting wheels which allows to carry out this activity in an automated way.

The robotic system is composed mainly of a robotic manipulator of at least 4 degrees of freedom which is mounted on a fixed and/or mobile system and is provided with a gripping mechanism to take anodes and deposit them in the cooling chain. When this is being performed, a vision system on the arm or outside of it carries out a first superficial inspection deciding whether to take the anode to the cooling section or to rejection. In this regard, most of the problems associated to the safety of the people and productivity of the current manual and/or mechanical process are eliminated.

### CROSS-REFERENCE TO RELATED APPLICATIONS

This application claims the benefit of provisional patent application Ser. No. 60/734,987 filed 2005 Nov. 10 by the present inventor

### FEDERAL SPONSORED RESEARCH

Not Applicable

### SEQUENCE LISTING OR PROGRAM

Not Applicable

### BACKGROUND

1. Field of Invention

This invention relates to the use of robotic technology in mining industry, specifically in casting wheels.

2. Prior Art

During metal obtention and refining processes, smelting furnaces are used to cast metal concentrates for purifying and extracting them. The first stage of the productive process is to move the dry concentrate to one of these furnaces, which could be a flash furnace and/or a Teniente converter, where casting is at temperatures over 1.200° C. In this way, while the concentrate becomes a molten liquid mass, its components are being separated and combined to form a two layer bath. The heaviest layer is called matte and it is a metal enriched component. Over this layer, the slag is floating, which is a coat of impurities from metals of interest. In this way and during successive stages, the stage which is rich in the metal is sequentially cast and refined through several furnaces which allows to obtain a high purity metal.

In the last stage of the smelting process, the fire refining stage is carried out in which the metal is processed in rotary furnaces, by adding special purifying agents which are called fluidizing agents to oxide and eliminate all the impurities with the resulting effect of very few non desired elements contained in the molten bath. Then, the oxygen is extracted with steam or oil injections with the final result of a high purity level.

Thus, when a metal load reaches the required purity level, the furnace is inclined and in exact quantities the metal is poured in one of the ingot casts of the fire refined casting wheel. Once the metal is poured into the cast, the wheel rotates to advance the following cast into the position and other ingot is cast. In this way, the wheel speed is adjusted in an accurate way to the optimum speed profile, ensuring a smooth positive and negative acceleration level of the casts. This is intended to produce high quality ingots with a minimum burr formation grade.

To finish the smelting process, the cast removing process (stripping and/or extraction) proceeds in which the cast ingots are lifted and sent to a cooling tank to avoid the excessive oxidation and to obtain a deep scrubbing.

Finally, the cast anodes are counted and arranged in predetermined bundles or at distances required by the electrolytic plant. The discharge of the cooling tanks is carried out whether by a forklift or by anode lifting devices.

One of the major disadvantages of the tasks associated to the anode casting and cast dislodging processes from the casting wheels is the exposure of the personnel to harsh environmental conditions, the non initial classification of the anodes and the high rate of failures of the current take off system. This, in the medium or long term, could generate serious occupational diseases to the operators in charge of carrying out these activities as well as delays in the anode production.

### SUMMARY

A robotic system and method for the removal and classification of anodes from the casting wheels in an automated way has been developed. The robotic manipulator takes the anodes from the casting wheel to the cooling section or to rejection

### DRAWINGS

### Figures

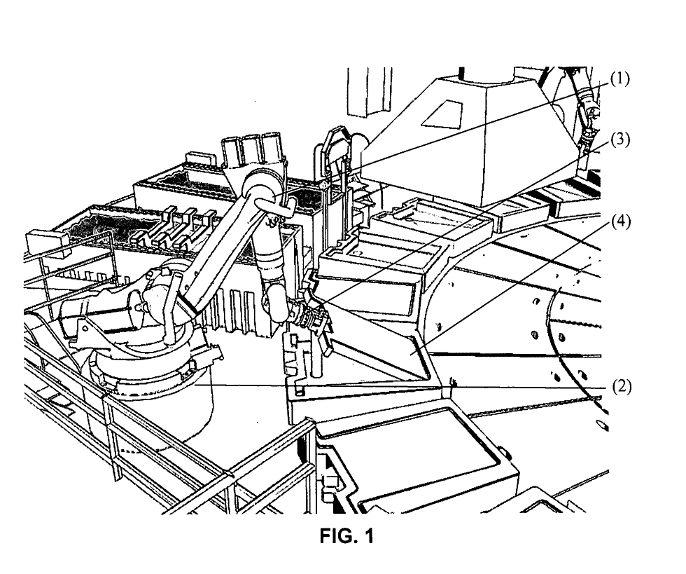

FIG. 1. View of the robot system and method for the removal and classification of the anodes from casting wheels

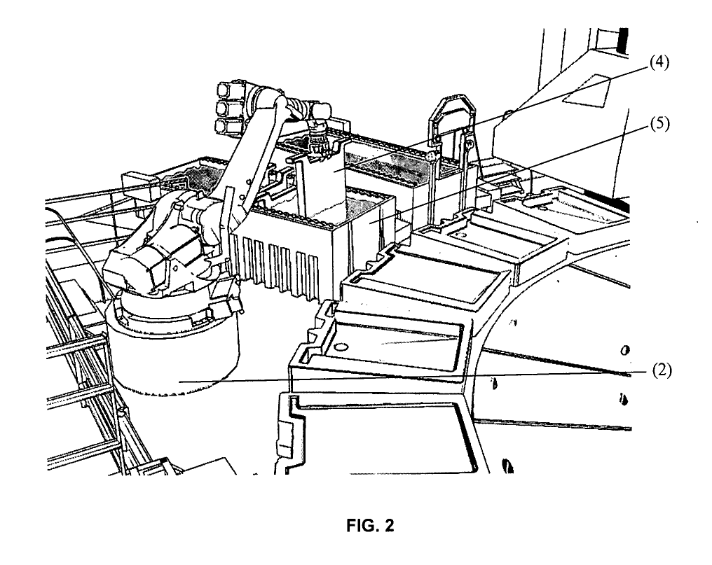

FIG. 2. View of the robot system and method for the removal and classification of the anodes from casting wheels

### DRAWINGS

### Reference Numerals

1. Robotic manipulator
2. Mounting system
3. Gripping mechanism
4. Anodes
5. Cooling chain

### DETAILED DESCRIPTION

This invention relates to a new robot system as well as an integral robotic method for the removal and classification of anodes from the casting wheels, comprising an anthropomorphous robotic manipulator of at least 4 degrees of freedom, with a gripping mechanism to carry out such activity in an automated way.

With reference to FIG. 1 and FIG. 2, the system is composed mainly of one anthropomorphous robotic manipulator of at least 4 degrees of freedom (1), provided with a communication, acquisition and control system, which is mounted on a fixed and/or mobile system (2), and a gripping mechanism (3) to allow, in a sequential and programmed way, to take anodes (4) to be deposited in the cooling chain (5). Once this is carried out, a vision system, located over the arm or outside, carries out the first superficial inspection thus deciding whether to take the anode to the cooling area or to rejection.

I claim:

1. A robot system for the dislodging process and/or anode handling from casting wheels, comprising an anthropomorphous robotic arm of at least 4 degrees of freedom, one control, communication and programming unit, one gripper adapter, one pneumatic gripper mechanism, one pneumatic gripper driving system, one vision system, an electrical supply system and one fixed or mobile tool holder wherein the anthropomorphous robotic manipulator of at least 4 degrees of freedom is provided with a gripping mechanism which allows in a sequential and programmed way to take, manipulate, and release the anodes from the casting wheels, so as to deposit them in a sequential and programmed way, in the cooling chain so as when this is performed a vision system located over the arm or outside carries out a first superficial inspection by deciding whether the anode goes to the cooling section or to rejection.

2. A robot system for the dislodging process and/or anode handling from casting wheels according to claim 1, wherein a gripping mechanism is used which allows in a sequential and programmed way to take, manipulate, and release the anodes from the casting wheels, so as to deposit them in a sequential and programmed way in the cooling chain.

3. A robot system for the dislodging process and/or anode handling from casting wheels according to claim 1, wherein the robotic manipulator could use a pneumatic, electric and/or hydraulic gripping mechanism, which allows to take, manipulate, and release the different tools and/or vision systems to be used according to the task to be performed.

4. A robot system the dislodging process and/or anode handling from casting wheels according to claim 1, wherein the anthropomorphous robotic manipulator could communicate by itself or through a PLC interface with the control system.

5. A robot system for the dislodging process and/or anode handling from casting wheels according to claim 1, wherein the anthropomorphous robotic manipulator has the capacity to obtain and interpret the information from installed analogue and/or digital sensors.

6. A robot system the dislodging process and/or anode handling from casting wheels according to claim 1, wherein the anthropomorphous robotic manipulator has the capacity to generate analogue and/or digital signals to control analogue and/or digital input devices.

7. A robot system for the dislodging process and/or anode handling from casting wheels according to claim 1, wherein it uses a vision system located over the robotic arm or outside to carry out the first superficial inspection thus deciding whether the anode goes to the cooling section or rejection.

8. A robot system for the dislodging process and/or anode handling from casting wheels according to claim 1, wherein it uses a tool holder from which the robotic manipulator takes several tools and/or vision systems to be used according to the task which is being performed.

9. A robot system the dislodging process and/or anode handling from casting wheels according to claim 1, wherein the robotic manipulator is mounted on a fixed and/or mobile support which allows to move to approach and/or move away from the casting wheel according to the task to be performed.

10. A robot system the dislodging process and/or anode handling from casting wheels according to claim 1, wherein the anthropomorphous robotic manipulator has an electrical and/or hydraulic system driven by three-stage induction motors, with vectorial y/o scalar control.

11. A robot system the dislodging process and/or anode handling from casting wheels according to claim 1, wherein it has the capacity to move and manipulate the different tools and/or vision systems in different paths within the work volume of the robotic manipulator.

12. A robot system for the dislodging process and/or anode handling from casting wheels according to claim 1, wherein it could be integrated to the removal and classification of anodes in any type of casting wheels, whether in smelting and/or conversion processes of copper or other metals such as (iron, zinc, nickel, silver, gold, tin, lead, etc.).

13. A robot system for the dislodging process and/or anode handling from casting wheels according to claim 1, wherein the system may operate automatically, or semi-automatically and also allows solutions scalability.

14. A robotic method for the dislodging process and/or anode handling from casting wheels using the robot System of claim 1 to 13, wherein the anthropomorphous robotic arm of at least 4 degrees of freedom is provided with a gripping mechanism which allows in a sequential and programmed way to take, manipulate, and release the anodes from the casting wheels in such a way that they are deposited in a sequential and programmed way, in the cooling chain so as once this is carried out, a vision system located on the arm or outside it carries out the first superficial inspection thus deciding whether the anode goes to the cooling section or to rejection.

15. A robotic method for the dislodging process and/or anode handling from casting wheels using the robot System of claim 1 to 13, wherein a gripping mechanism is used to take, manipulate and release in a sequential and programmed way the anodes from the casting wheels, so as they are deposited in a sequential and programmed way in the cooling chain.

16. A robotic method for the dislodging process and/or anode handling from casting wheels using the robot System of claim 1 to 13, wherein the robotic manipulator may use a pneumatic, electric and/or hydraulic gripping mechanism, which allows to take, manipulate and release the different tools and/or vision systems according to the task to be performed.

17. A robotic method for the dislodging process and/or anode handling from casting wheels using the robot System of claim 1 to 13, wherein the anthropomorphous robotic manipulator could communicate by itself or through a PLC interface with the control system.

18. A robotic method for the dislodging process and/or anode handling from casting wheels using the robot System of claim 1 to 13, wherein the anthropomorphous robotic manipulator has the capacity to obtain and interpret the information from installed analogue and/or digital sensors.

19. A robotic method for the dislodging process and/or anode handling from casting wheels using the robot System of claim 1 to 13, wherein the anthropomorphous robotic manipulator has the capacity to generate analogue and/or digital signals to control the analogue and/or digital inputs devices.

20. A robotic method for the dislodging process and/or anode handling from casting wheels using the robot System of claim 1 to 13, wherein it uses a vision system located over the robotic arm or outside, so as it is used to carry out a first superficial inspection thus deciding whether the anode goes to the cooling section or rejection.

21. A robotic method for the dislodging process and/or anode handling from casting wheels using the robot System of claim 1 to 13, wherein it uses a tool holder from which the robotic manipulator takes the different tools and/or vision systems according to the task being performed.

22. A robotic method for the dislodging process and/or anode handling from casting wheels using the robot System of claim 1 to 13, wherein the robotic manipulator is mounted on a fixed and/or mobile support to move to approach and/or move away from the casting wheel according to the task to be performed.

23. A robotic method for the dislodging process and/or anode handling from casting wheels using the robot System of claim 1 to 13, wherein the anthropomorphous robotic manipulator has an electrical and/or hydraulic system driven by three-stage induction motors with vectorial and/or scalar control.

24. A robotic method the dislodging process and/or anode handling from casting wheels using the robot System of claim 1 to 13, wherein it has the capacity of moving and manipulating the different tools and/or vision systems in different paths within the work volume of the robotic manipulator.

25. A robotic method for the dislodging process and/or anode handling from casting wheels using the robot System of claim 1 to 13, wherein it could be integrated to the removal and classification of anodes in any type of casting wheel, whether in smelting and/or conversion processes of copper and other metals (iron, zinc, nickel, silver, gold, tin, lead, etc.).

26. A robotic method for the dislodging process and/or anode handling from casting wheels using the robot System of claim 1 to 13, wherein the system may operate automatically or semi-automatically, and also allows solution scalability.
